(19) United States
(12) Patent Application Publication
(10) Pub. No.: US 2002/0195732 A1
(43) Pub. Date: Dec. 26, 2002

(54) Apparatus and method for identifying ophthalmic molds

(76) Inventors: Michael J. Clark, Rochester, NY (US); Eric Colin, Earlscourt (IE); Robert G. Duggan, Piltown (IE); Oran F. K. McGrath, Drinagh (IE)

Correspondence Address: Katherine McGuire, Bausch Lomb Incorporated, One Baush & Lomb Place, Rochester, NY, 14604, US

(21) Appl. No.: 09/885,557

(22) Filed: Jun. 20, 2001

(51) Int. Cl. B29D 11/00

(52) U.S. Cl. 264/2.5; 264/408; 425/808; 249/103

(57) ABSTRACT

Method and apparatus for applying an identifying mark to a mold used for making an ophthalmic device whereby the mold may be identified at various points along a production line in a fast, reliable and automatic manner. The mark is applied to a non-optical surface of the mold and is read using a reading device and a light source positioned on either side of the mold whereby the light rays enhance the contrast between the identifying mark and the mold. In a preferred embodiment, the identifying mark is a 2D matrix which is formed on the non-optical mold tool used in the injection mold machine which makes the mold. The 2D matrix on the non-optical mold tool is then replicated on the non-optical surface of the mold.

### BACKGROUND OF THE INVENTION

The present invention generally relates to mold identification in a manufacturing facility, and more particularly relates to an improved method of marking a mold used for making an ophthalmic lens such that the mold can be quickly and accurately identified at various points throughout the manufacturing operation.

One well known process of making ophthalmic devices such as contact lenses, spectacle lenses, intraocular lenses, etc., is molding the ophthalmic device from a liquid lens material (e.g., a monomer) which is cured in the mold and then released from the mold in a solid state. In one such known process which is used to make contact lenses, mating male and female mold halves are used to form a single lens.

The mold halves themselves are typically injection molded parts which are recycled after a single use. The female mold section includes an concave surface for forming the convex, anterior surface of the lens (facing away from the eye when worn) while the male mold half has a convex surface for forming the opposite, concave, posterior surface of the lens (lying against the eye when worn). During the lens molding operation, the concave surface of the female mold half is positioned to receive a quantity of liquid lens material and the convex surface of the male mold half is then seated against the concave surface of the female mold half to form a lens-shaped cavity therebetween in which the lens is cured and formed. Once the lens is formed, the male mold half is separated from the female mold half and the lens is released therefrom.

Since the concave surface of the female mold and the convex surface of the male mold are directly forming the opposite surfaces of the lens, these surfaces must be optically correct and great care is taken in their formation. When injection molding the mold halves, an optical tool, typically made of an alloy such as stainless steel or beryllium copper, is provided in the injection mold cavity to form the optical surface of the mold half. Thus, in the case of a female mold half, an optical tool having a convex surface is used to form the optical concave surface of the female mold half The concave surface of the female mold half then forms the convex surface of the lens (i.e., the anterior lens surface). In the case of the male mold half, an optical tool having a concave surface is used to form the optical convex surface of the male mold half. The convex surface of the male mold half then forms the concave surface of the lens (i.e., the posterior lens surface).

The above-described process is typically referred to as static cast molding. Another process for making ophthalmic lenses uses only a female mold to cast the anterior surface of the lens (e.g., by a process known as spin-casting). A cutting operation (e.g., lathing) is performed on the opposite surface to form the posterior surface of the lens. The present invention is applicable to either method of lens production.

In the manufacture of ophthalmic molds, it is often necessary to be able to identify the mold at different stages of the manufacturing process. For example, if there is a defect discovered in a finished ophthalmic device, it is important to know where and how the defect occurred during the manufacturing process. This necessitates being able to identify the mold which made the defective ophthalmic device. An identifying mark may thus be applied to the mold which indicates, for example, the respective injection mold machine and mold cavity within the machine which formed that particular mold part. Further information, such as identifying the exact production run of the mold machine for a particular molded part, may also form part of the identifying mark. The identifying mark may be of any type, for example, a series of letters and/or numerals, a bar code, a matrix, a series of dots and/or lines, etc., which are indicative of the information desired to be placed on the mold part.

While there are numerous examples of prior art methods for providing an identifying mark to a finished ophthalmic article (see, e.g., U.S. Pat. Nos. 4,219,721; 5,467,149; 5,960,550 and 6,203,156), there is virtually no discussion in the prior art of placing a mark on an ophthalmic mold for identifying the mold through a production line. There therefore exists a need for a method of applying an identifying mark on an ophthalmic mold which permits quick identification of the ophthalmic mold at various points along the production line, while also not interfering with the optical quality surfaces of the mold. It would also be desirable to automate the mold identification process to eliminate human error and reduce time in reading the identifying mark.

### SUMMARY OF THE INVENTION

The present invention successfully addresses the need for applying an identifying mark on an ophthalmic mold which does not interfere with the optical surface of the mold and permits rapid, automated identification of the mold at any desired point along the production line.

As described above, the mold used for casting an ophthalmic lens is typically injection molded using an optical tool for forming the optical surface of the mold. The surface of the mold opposite the optical surface is also formed with the use of a tool placed opposite the optical tool in the injection mold cavity. This tool is non-optical in the respect that it is not forming an optical surface on the mold, but rather merely provides a structural surface of the mold. This tool will thus be referred to hereinafter as the “nonoptical tool”.

In a common mold configuration, this non-optical surface of the mold is the reverse profile of the optical surface of the mold. Thus, for a female mold having a concave optical surface, the opposite, non-optical surface of the female mold is convex and the non-optical injection mold tool thus has a concave surface. The surface profiles are reversed in the case of a male mold having a convex optical surface where the non-optical surface of the male mold is concave and the non-optical injection mold tool thus has a convex surface.

The present invention provides an apparatus and method for applying an identifying mark to the non-optical surface of a mold which is subsequently read and deciphered using a suitable imaging device. Common materials for injection molding the molds are translucent materials such as polyvinylchloride, for example, which permit light rays to pass through the mold from the optical to the non-optical surface thereof. An identifying mark which contrasts with the translucent mold material is applied to the non-optical surface of the mold which may then be passed over an imaging device to read and decipher the mark.

### BRIEF DESCRIPTION OF THE DRAWING

FIG. 1 is a perspective view of a contact lens mold with the male mold half shown spaced above the female mold half and a contact lens spaced therebetween;

FIG. 2 is a cross-sectional view of an assembled contact lens mold as taken generally along the line 2-2 of FIG. 1;

FIG. 3 is a cross-sectional view of a cavity of an injection mold machine used for making a female mold half;

FIG. 4 is a plan view of a contact lens mold having an identifying mark thereon; and

FIG. 5 is an elevational view of a mold half in cross-section shown spaced between a light source and a device for reading and deciphering the mark on the mold.

### DETAILED DESCRIPTION

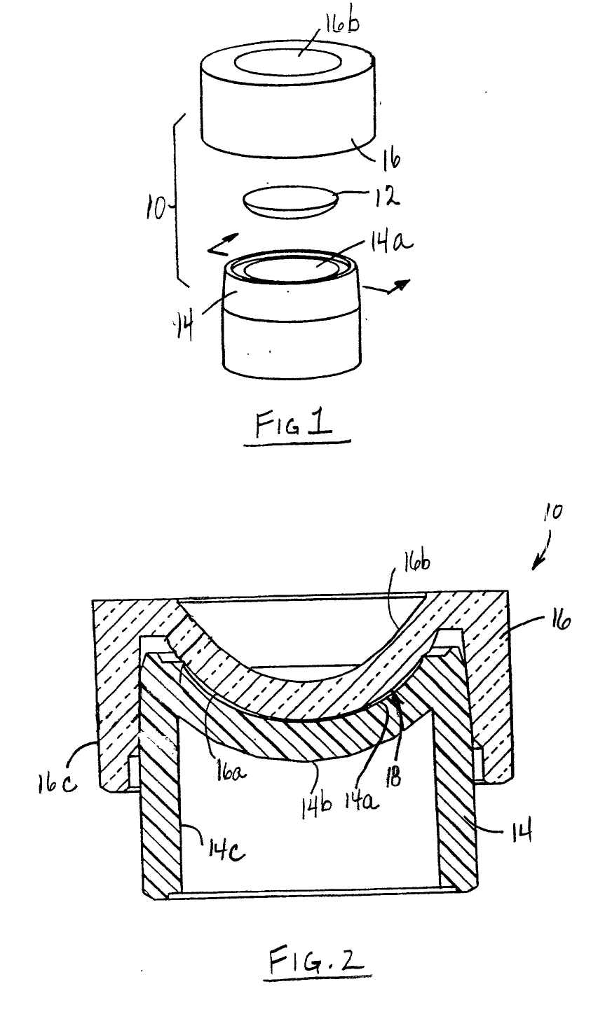

Referring now to the drawing, there is seen in FIGS. 1 and 2 a mold assembly 10 used for making a contact lens 12. Mold assembly 10 includes a female mold half 14 and male mold half 16 which fit together to form a lens-shaped cavity 18 therebetween in which lens 12 is molded. Mold halves 14, 16 are typically formed by injection molding using a translucent material such as polyvinylchloride, for example. It is noted that the invention is not limited to the particular mold assembly configuration shown herein but may be used with many other mold configurations used for making ophthalmic devices.

Female mold half 14 includes a concave optical surface 14a and opposite non-optical surface 14b (FIG. 2) which is the reverse profile of optical surface 14a (i.e., convex). Male mold half 16 includes a convex optical surface 16a and opposite, non-optical surface 16b which is concavely shaped. To cast a contact lens 12 in mold assembly 10, a quantity of liquid lens material is dispensed into the concavity of optical surface 14a and male mold half 16 is seated upon female mold half 14 which disperses the lens material between facing female and male optical mold surfaces 14a, 16a, respectively. The lens material is allowed to cure and the male mold half 16 is then lifted from the female mold half 14 to retrieve the finished lens 12 therefrom.

Having described the basic method of static cast molding a contact lens, discussion is now turned to the application of the identifying mark to the mold so that the mold may be easily identified at various points along a contact lens or other optical device production line.

As described above, each mold half includes an optical surface 14a, 16a used for molding the corresponding optical surfaces of the contact lens. Since the optical surfaces of the molds are making the optical surfaces of the lens itself, it is critical that these surfaces be clear of defects which would interfere with the formation of a correct optical surface on the cast lens. Placement of the identifying mark on the mold is therefore important in the regard that it cannot interfere with maintaining a correct optical surface of the mold. In the embodiment shown herein, the identifying mark 20 is applied to the non-optical surface 14b of the mold half located opposite the optical surface 14a thereof (FIG. 5). As such, the identifying mark 20 does not interfere with the optical mold surface 14a, yet may be easily scanned by a reading device 22 to read and decipher the identifying mark 20. If needed, a light source 24 may be positioned at the opposite side of mold half 14 to pass light rays through mold half 14 to enhance the contrast between the mold body and the identifying mark 20. Reading device 22 may be any suitable type, such as the Cosi 800 for Laetus division of Romaco GmbH, for example.

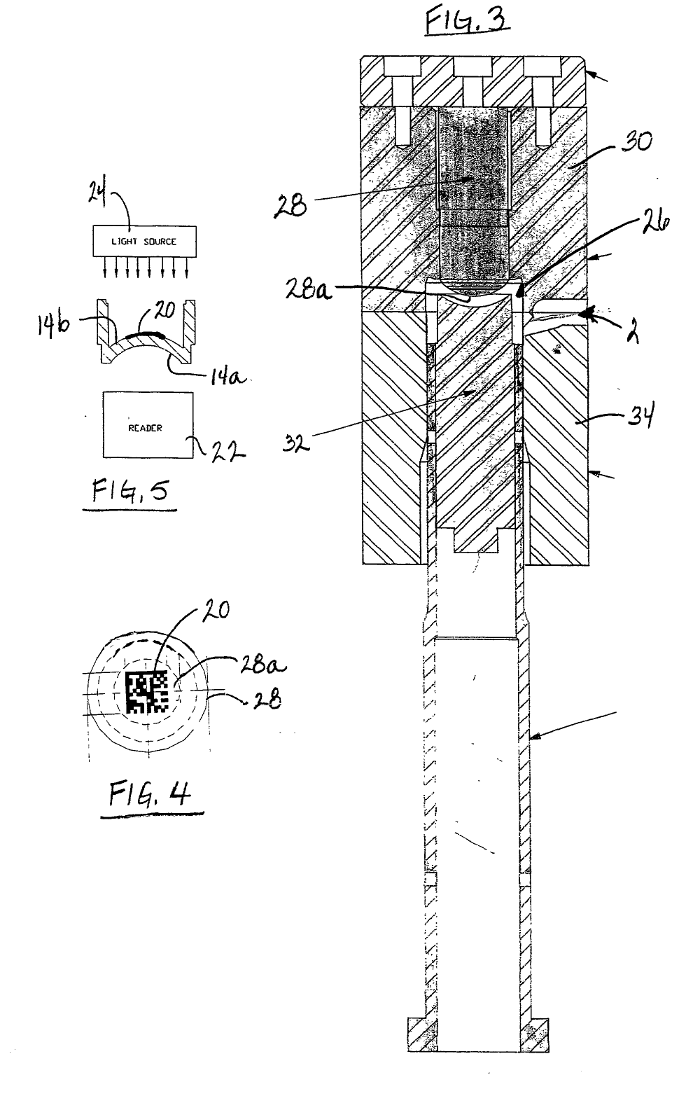

Various methods may be used for applying identifying mark 20 to the mold half, e.g., printing, stamping, laser etching, engraving, etc. In the preferred embodiment, identifying mark 20 is applied to the mold half when the mold half is made by forming the identifying mark into the surface of the mold. A representative mold cavity configuration of an injection mold machine is seen in FIG. 3 which in this case is set up to make a female mold half 14. The mold cavity is indicated at 26 which is defined on one side by an optical tool 28 positioned in a first cavity block 30, and on the other side by a non-optical tool 32 positioned in a second cavity block 34. To form the identifying mark 20 on non-optical mold surface 14b, the identifying mark is carried on the surface of the non-optical tool 32.

The identifying mark may be of any desired type and configuration to provide any desired type of information regarding the mold half as described above. Also, the identifying mark 20 may be applied to non-optical tool 32 in any desired manner, e.g., laser etching, engraving, chemical etching, etc., whereby the identifying mark is replicated from the tool to the mold. Thus, if the identifying mark 20 is applied as a recessed etch in tool surface 28a, the identifying mark 20 is replicated in reverse profile as raised surface portions 20 in the mold half These raised surface portions provide sufficient contrast with the mold half whereby their configuration may be read and deciphered by the reading device 22. One preferred type of identifying mark 20 is a 2D matrix mark seen applied to non-optical tool surface 28a in FIG. 4. In a preferred embodiment, the identifying mark 20 is laser etched into the tool surface 28a at a depth of about 8-20 μm, and is code type ECC200, a 2-dimensional, machine-readable matrix from the code listings of AIM International, a standards organization of machine-readable identification symbology.

Thus, mold half 14 is formed when liquid mold material is injected through gate 25 which leads into mold cavity 26 with optical tool 28 forming the optical surface 14a of mold half 14 and non-optical tool 32 forming non-optical surface 14b thereof. As the mold material solidified within cavity 26, the identifying mark 20 is replicated into the non-optical surface 14b of the mold half Once the mold half has solidified, the cavity is opened and the mold half 14 is ejected from the mold machine, having the identifying mark 20 permanently affixed thereto for subsequent reading and deciphering as needed (e.g., at production stages such as mold injection molding, mold storage, spincasting station, lens lathing, lens hydration, and/or lens release). In this way, the mold halves may be identified at any desired location along a production line using a reader which is fast, reliable and automatic.

It is noted that the exact placement of the identifying mark on the mold may vary depending on the specific mold configuration employed. As long as the placement of the mark does not interfere with the optical surface of the mold, the placement of the mark 20 on the mold may vary as desired. For example, in the embodiment of mold 10 shown and described herein, identifying mark 20 may alternately be applied to the cylindrical wall 14c, 16c of mold halves 14, 16, since this would not interfere with the optical surfaces 14a, 16a thereof, respectively. In this instance, the reader 22 and light source 24 would need to be positioned on either side of the applicable cylindrical wall to read the identifying mark 20 applied thereto.

What is claimed is:

1. A method for identifying a mold used for making an ophthalmic device, said mold having an optical mold surface for replicating an optical surface of said ophthalmic device, and a non-optical surface, said method comprising the steps of:
a) applying an identifying mark to said non-optical mold surface; and
b) providing an automatic reading device for reading said identifying mark.

2. The method according to claim 1, and further comprising the step of passing light rays through said mold during said reading step.

3. The method according to claim 1, wherein said non-optical surface of said mold is located opposite said optical surface of said mold.

4. The method of claim 3 wherein said optical surface and said non-optical surface are reverse profiles of each other.

5. The method of claim 4 wherein said mold is a female mold half having a concave optical mold surface and a convex non-optical mold surface and said identifying mark is applied to said non-optical mold surface.

6. The method of claim 4, and further comprising the step of passing light rays through said mold half during said reading step.

7. The method of claim 6 wherein said mold half is passed between a reading device and a light source during said reading step.

8. The method of claim 7 wherein said mold is injection molded.

9. The method of claim 8 wherein said identifying mark is applied to a non-optical injection mold tool which is replicated to said non-optical surface of said mold during the injection molding process of said mold.

10. The method of claim 9 wherein said identifying mark is applied to said non-optical injection mold tool utilizing an etching process.

11. The method of claim 1 wherein said identifying mark is a 2D matrix type mark.

12. An ophthalmic mold including an optical surface and a non-optical surface, said mold further including an identifying mark located on a portion of said non-optical surface.

13. The mold of claim 12 wherein said identifying mark is a machine-readable mark.

14. The mold of claim 13 wherein said identifying mark is a 2-dimensional matrix mark.

15. A mold for making an ophthalmic device, said mold having an optical surface and a non-optical surface located opposite said optical surface, said mold further including an identifying mark on said non-optical surface.

16. The mold of claim 15 wherein said mold optical surface is adapted to replicate the anterior surface of a contact lens.
